(19) United States
(12) Patent Application Publication
(10) Pub. No.: US 2021/0316429 A1
(43) Pub. Date: Oct. 14, 2021

(54) TOOL FOR MOUNTING A SEAL IN A GROOVE OR GAP ON A WIND TURBINE

(71) Applicant: Siemens Gamesa Renewable Energy A/S, Brande (DK)

(72) Inventor: Paw Bjerre Lang, Silkeborg (DK)

(21) Appl. No.: 17/266,727

(22) PCT Filed: Aug. 28, 2019
(86) PCT No.: PCT/EP2019/072902

§ 371 Date: Feb. 8, 2021

(30) Foreign Application Priority Data
Aug. 29, 2018 (EP) 18191525.7

(51) Int. Cl. B25B 27/00; B25D 17/00; B25D 17/02

(52) U.S. Cl. CPC B25B 27/0092; B25D 17/005; B25D 2250/355; B25D 2217/0007; B25D 17/02

(57) ABSTRACT

Provided is a tool for mounting a seal in a groove or gap on a wind turbine, the tool including: a roller configured for rolling along the seal and in contact therewith, and a hammer unit configured for exerting a hammering action on the roller to push the seal or a portion thereof into the groove or gap as the roller rolls along the seal, wherein the tool includes a battery powering the hammer unit. Advantageously, the tool combines a rolling action with a hammering action to provide for easy mounting of the seal on the wind turbine.

### CROSS-REFERENCE TO RELATED APPLICATIONS

This application claims priority to PCT Application No. PCT/EP2019/072902, having a filing date of Aug. 28, 2019, which is based on EP Application No. 18191525.7, having a filing date of Aug. 29, 2018, the entire contents both of which are hereby incorporated by reference.

### FIELD OF TECHNOLOGY

The following relates to a tool for mounting a seal in a groove or gap on a wind turbine, and to a corresponding method.

### BACKGROUND

Wind turbines comprise a rotor driving a generator mounted inside a nacelle on top of a tower. The rotor has a plurality of blades mounted to a hub. The hub is connected to the generator by a main shaft.

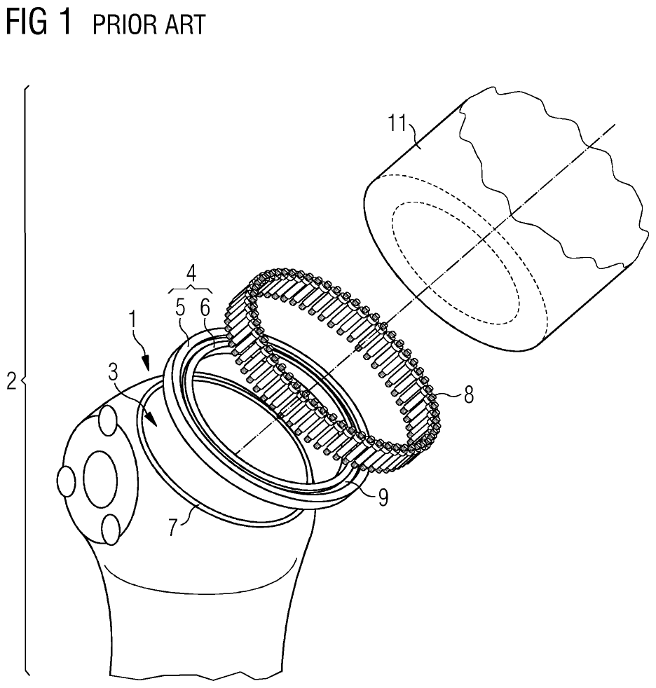

Each blade is mounted to the hub using a blade bearing. FIG. 1 shows a conventional art hub 1 of a wind turbine 2 (only shown partially). The hub 1 comprises openings 3 for each blade 11. Further, FIG. 1 shows a blade bearing 4 having an outer race 5 and an inner race 6 connected to each other by roller elements (not shown). The outer race 5 is bolted to a flange portion 7 of the hub 1 using a plurality of bolts 8. The hub 1, the blade bearing 4, the bolts 8 and the blade 11 are shown in an exploded view.

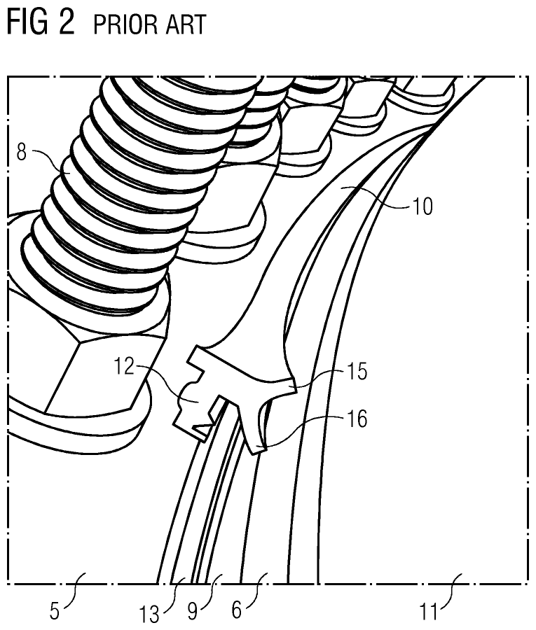

In between the outer race 5 and inner race 6 there is a gap 9 being formed. The gap 9 needs to be sealed with a seal 10 shown in FIG. 2. FIG. 2 shows a conventional art way of fitting the seal 10. FIG. 2 also depicts a portion of the blade 11 fastened to the inner race 6.

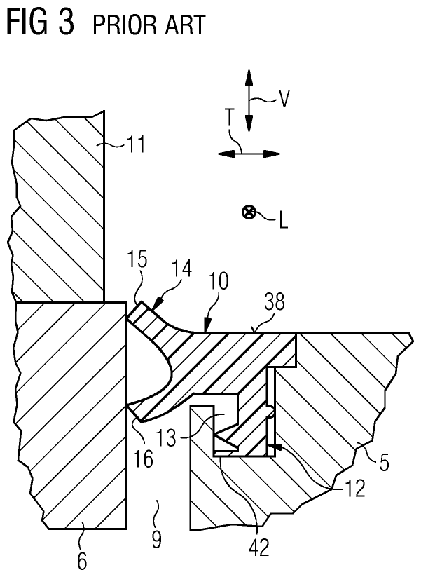

FIG. 3 shows the seal 10 of FIG. 2 in a cross-sectional view, and, very schematically, the outer race 5, the inner race 6 and the blade 11 in partial cross-section. According to the conventional art, the seal 10 comprises a first portion 12 fitted inside a groove 13 of the outer race 5. The first portion 12 being formed from an elastic material needs to be pushed (force-fitted) into the groove 12 when mounting the seal 10 to the blade bearing 4. At the same time, when the first portion 12 of the seal 10 is fitted into the groove 13, a second portion 14 of the seal 10 closes the gap 9 (see FIG. 2) in order to seal the same. The second portion 14 comprises two lips 15, 16 which get to spread out when the seal 10 is fitted and are elastically biased with their free ends against the inner race 6.

The seal 10 needs to be replaced at regular intervals during the operation of the wind turbine, for example far out at sea. Such replacement is indicated when, for example, grease starts leaking out onto the blade surface adjacent to the seal 10 from inside the blade bearing 4. The grease is used to lubricate the roller elements rolling in between the outer and inner race 5, 6.

The hub 1 (FIG. 1) is housed in a glass fiber housing (not shown). The housing has a manhole facing the nacelle. In order to replace a worn seal 10, maintenance personnel needs to climb up the tower and enter the nacelle of the wind turbine. The personnel then enters the housing of the hub from the nacelle through the manhole. Of course, at this point in time, the rotor is standing still, with the blade bearing 4 which needs to have its seal 10 replaced facing upwards, i.e. the blade 11 held by the blade bearing 4 is extending vertically upwards.

Inside the housing, the personnel proceeds to the worn seal 10. The worn seal 10 is removed from the blade bearing 4 using a screwdriver, for example. To this end, the screwdriver is forced, for example, between the outer race 5 and the seal 10, and the seal 10 is removed by using the screwdriver as a lever to force out, in particular, the first portion 12 out of the groove 13 (see FIG. 3).

Once the worn seal 10 has been removed, it is replaced with a new seal 10. Initially, the new seal 10 is wrapped circumferentially around the blade root, and the two free ends of the seal 10 are connected to each other. Then, by hand, the seal 10 is connected to the blade bearing 4, for example, by pushing the first portion 12 into the groove 13 and the second portion 14 into the space 9 (see FIGS. 2 and 3).

The process of fitting the new seal 10 is difficult for a number of reasons. First, the use of any tools, such as screwdrivers, is not desirable since such tools can easily damage the new seal 10. Second, space is very limited inside the housing. From an ergonomic perspective, it is thus quite difficult to work on the new seal 10. Third, the forces required to fit the new seal 10 on the blade bearing 4 are relatively high.

### SUMMARY

An aspect relates to an approved approach to mounting a seal in a groove or gap on a wind turbine.

Document CN 204935525 U discloses a sealing strip installation tool, which comprises a support part, a driving part and a pressing part, wherein vibration force generated by reciprocating motion of a pneumatic vibrator is transmitted to the pressing roller, and the pressing roller. Further, conventional art is disclosed in DE4327067A1 and U.S. Pat. No. 4,569,261.

Accordingly, there is provided a tool for mounting a seal in a groove or gap on a wind turbine, the tool comprising a roller and a hammer unit. The roller is configured for rolling along the seal and in contact therewith. The hammer unit is configured for exerting a hammering action on the roller to push the seal into the groove or gap as the roller rolls along the seal.

This tool is well suited to the task at hand since it combines a rolling action with a hammering action. Not only can the seal be mounted quickly and efficiently in this manner, but also, using a roller, damage to the new seal is prevented.

Advantageously, the roller is rolled along the seal manually since it is, at times, quite difficult to follow the geometry of the seal, especially when the seal is not sitting in the groove or gap yet.

Automating this step would be quite difficult. Yet, this is not to say that an automated rolling of the roller along the seal is excluded by embodiments of the invention.

On the other hand, the hammering action requires a movement difficult to perform manually in the limited space available within the housing of the hub. Also, the hammering action requires a lot of force on the part of the personnel, and is therefore quite tiring. Thus, using a hammer unit greatly simplifies the step of fitting the new seal.

Herein, a “wind turbine” is a device to convert the wind's kinetic energy into electrical energy.

Herein, “seal” refers to an elastic element arranged between two moving parts and sealing a gap therebetween. The seal is to provide a closed or substantially closed volume within which a lubricant lubricating movement between the moving parts is contained. On the other hand, the seal prevents ingress of external substances such as water or dust. For example, the seal is a bearing seal. The seal may have a constant or substantially constant cross-section along its length. The cross-section may comprise one or more portions force-fitted inside the groove or gap. “Force-fitted” refers to a connection between the one or more portions and the groove or gap, wherein it is frictional forces between the seal and the groove or gap which provide the connection. The seal and/or its one or more portions may comprise lips, arms or other elastic protrusions to provide sealing and/or holding forces between the seal and the part which the seal is fitted to (groove or gap) and the part against which the seal provides its sealing action. The seal may have a length of more than 1 m, more than 2 m, more than 5 m or more than 10 m. The free ends of the seal may be connected to each other, for example using an adhesive.

Herein, “groove” refers to a recess having a constant or substantially constant cross-section, wherein the cross-section is open on one side and closed on the other sides. For example, the groove may be U-shaped. The seal or a portion thereof may be fitted into the groove through the open side. The groove can be, for example, formed in the outer race of a bearing.

Herein, a “gap” refers to an opening between two parts having a constant or substantially constant width. The gap is thus defined between at least two walls of different components, such as an outer and an inner race of a bearing. The gap does not have a closed third side such as the groove.

Herein, a “roller” has a circular circumferential surface configured to roll on the seal. The roller may have a wheel or drum shape. In a wheel shape, the width of the roller in the axial direction is smaller than its diameter in the radial direction. “Axial” and “radial” refer to the axis around which the roller rotates as it rolls. A drum shape means a shape of the roller where its width is larger than its diameter.

Herein, a “hammer unit” is a unit for automatically providing the hammering action using electrical power, pneumatic power or hydraulic power. The “hammering action” refers to a high acceleration movement of the roller towards the seal. Thereafter, the roller is retracted. During the return movement, the roller may or may not lose contact with the seal. This reciprocating motion may have a frequency of, for example, 1 to 50 Hz.

According to an embodiment, the roller is configured to engage the seal in a direction transverse with respect to the rolling direction.

Thereby, slipping off of the roller from the seal is prevented. The direction in which the roller and the seal engage is colinear with the axis along which the reciprocating movement of the roller takes place.

According to a further embodiment, the roller has, on its circumference, a groove configured to engage a protrusion on the seal.

In this manner, a simple way of engaging the roller with the seal is provided. Also, the engagement of the groove and the protrusion is maintained as the roller rolls along the seal.

According to a further embodiment, the tool is a hand-held tool.

The tool is, in terms of weight and size, configured to be operated and held by a human. One or more helves or handles are provided to hold the tool by hand.

The tool comprises a battery powering the hammer unit.

Thus, the tool does not require a physical connection providing the power used by the hammer unit. This simplifies the operation of the tool.

According to a further embodiment, the roller is releasably connected to the hammer unit.

Thus, different types of rollers may be used with the same hammer unit. This is particularly useful when the rollers are adapted to different types of seals, for example such seals having protrusions of different geometries or no protrusion at all.

According to a further embodiment, the tool comprises a roller unit having the roller and a mount, wherein the hammer unit has a chuck receiving the mount for providing the releasable connection.

In particular, the mount can be a standard mount such that the roller can be mounted on any standard hammer unit available in the market.

According to a further embodiment, the tool comprises a bracket having two legs and a dowel pin, wherein the roller is held rotatably by the dowel pin between the legs.

According to a further embodiment, the seal is a blade bearing seal.

The tool is particularly useful in the context of blade bearing seals as outlined in the introduction.

According to a further aspect, a method for mounting a seal in a groove or gap on a wind turbine is provided. The method comprises: rolling a roller along the seal and in contact therewith; exerting, by a hammer unit, a hammering action on the roller to push the seal or a portion thereof into the groove or gap as the roller rolls along the seal.

According to an embodiment, the roller engages the seal in a direction transverse with respect to the rolling direction.

According to a further embodiment, the roller has, on its circumference, a groove engaging a protrusion on the seal.

According to a further embodiment, the tool is hand-held.

The tool comprises a battery powering the hammer unit.

According to a further embodiment, the seal is a blade bearing seal.

According to a further embodiment, the wind turbine has a hub, a blade and a blade bearing connecting the blade to the hub, wherein the blade bearing has an inner and outer race forming a gap therebetween, wherein the outer race has the groove in which the seal is mounted to seal the gap.

Further possible implementations or alternative solutions of embodiments of the invention also encompass combinations—that are not explicitly mentioned herein—of features described above or below with regard to the embodiments. The person skilled in the art may also add individual or isolated aspects and features to the most basic form of embodiments of the invention.

### BRIEF DESCRIPTION

Some of the embodiments will be described in detail, with references to the following Figures, wherein like designations denote like members, wherein:

FIG. 1 shows, in a perspective exploded view, a hub, a blade bearing, bolts for mounting the blade bearing to the hub and a blade;

FIG. 2 shows, in a perspective view, a seal being mounted to the blade bearing of FIG. 1;

FIG. 3 shows a cross-section of the seal shown in FIG. 2, and a portion of the outer race, the inner race and the blade;

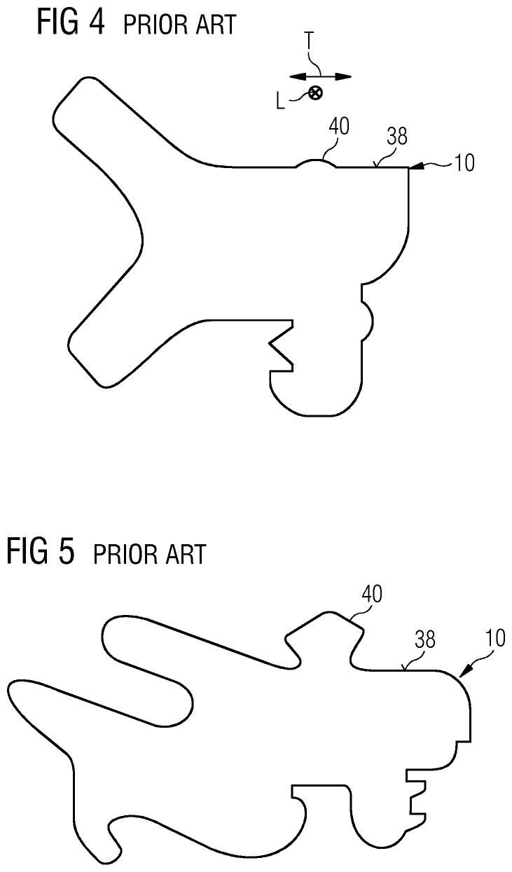

FIG. 4 shows, in a cross-section, a seal according to a further embodiment;

FIG. 5 shows, in a cross-section, a seal according to a further embodiment;

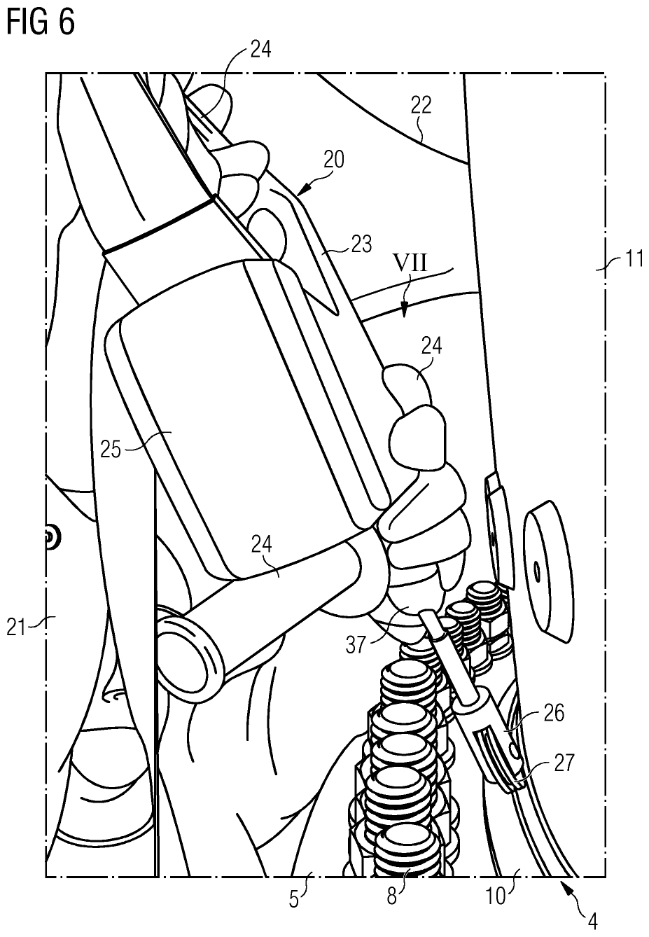

FIG. 6 shows, in a perspective view, a worker mounting a seal on a wind turbine using a tool in accordance with an embodiment;

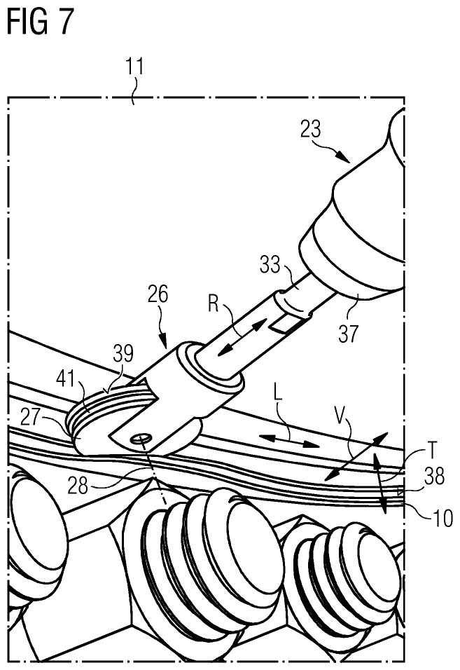

FIG. 7 shows a view VII from FIG. 6;

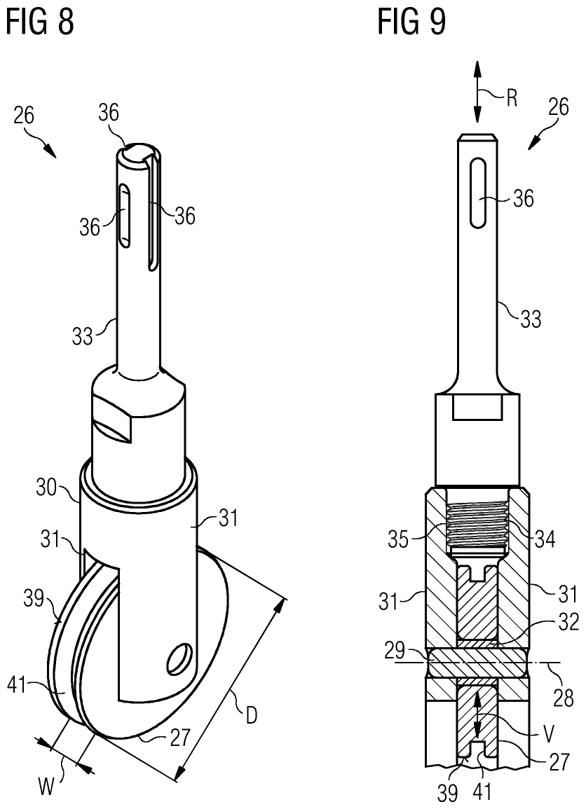

FIG. 8 shows, in a perspective view, a roller unit of the tool used in FIGS. 6 and 7; and

FIG. 9 shows a lengthwise cross-section through the roller unit of FIG. 8.

### DETAILED DESCRIPTION

FIG. 6 shows, in a perspective view, a tool 20. The tool 20 is held by a maintenance person (worker) 21 standing or kneeling inside a glass fiber housing 22 housing the hub 2 (see FIG. 1). Further, FIG. 6 shows the blade 11 connected to the inner race 6 (see FIG. 1). The outer race 5 is connected, using bolts 8, to the flange portion 7 (FIG. 1) of the hub 1. After having removed the worn seal (not shown) using, for example, a screwdriver, the new seal 10 is fitted to the blade bearing 4 using the tool 20.

The tool 20 comprises a hammer unit 23. Helves or grips 24 (for example three helves or grips) are provided allowing the tool 20 to be held by hand when operated. The helves or grips 24 are connected to the hammer unit 23. Also, a rechargeable battery pack 25 is connected to the hammer unit 23 and provides electrical energy for its operation (hammering action).

Further, the tool 20 comprises a roller unit 26 connected to the hammer unit 23 as also shown in FIG. 7 illustrating a view VII from FIG. 6. Details of the roller unit 26 will be explained referring to FIGS. 8 and 9. FIG. 8 shows a perspective view of the roller unit 26. FIG. 9 shows a cross-section of the roller unit 26.

The roller unit 26 has a roller 27. The roller unit 27 is configured to rotate around an axis 28 defined by a dowel pin 29. The roller 27 may be formed as, for example, a wheel, having a width W smaller than a diameter D. Therein, the width W refers to a dimension of the roller 27 parallel to the axis 28. The diameter D refers to a direction radial with respect to the axis 28.

Furthermore, the roller unit 26 comprises a bracket 30. The bracket 30 has two legs 31. The dowel pin 29 holds the roller 27 between the legs 31. A bearing 32 may hold the roller 27 rotatably on the dowel pin 28.

Further, the roller unit 26 may comprise a mount 33. The mount 33 is, at its one end, provided with a thread 34 by which it is screwed into a threaded bore 35 in the bracket 30 on the side opposite of the legs 31. At its other end, the mount 33 has grooves 36 or other means which allow the roller unit 26 to be connected to a chuck 37 (see FIG. 7) of the hammer unit 23.

Returning to FIG. 7, it can be seen that the roller 27 is brought into contact with an upwards facing upper surface 38 of the seal 10 with its circumferential surface 39 (see FIGS. 8 and 9). The outer surface 38 of the seal 10 is also indicated in FIG. 3.

As the worker 21 now moves the tool 20 in the lengthwise direction L of the seal 10, the roller 27 rotates around the axis 28 due to frictional forces between the roller 27 and the seal 10. The lengthwise direction L runs parallel to the perimeter of the blade 11 and is, effectively, a circle, since the seal 10 is connected at its free ends, for example, by an adhesive.

The circumferential surface 39 (see FIG. 8) of the roller 27 may be formed as a flat surface in cases where the corresponding outer surface 38 of the seal 10 is configured flat as shown for the seal 10 of FIG. 3. On the other hand, seals 10 may be used with protrusions 40 as shown in FIGS. 4 and 5. Such protrusions 40 may have a constant cross-section in the lengthwise direction L of the seal 10. The roller 27 may comprise, on its circumferential surface 39, a groove 41 (FIG. 8) for engaging the protrusion 40 in the vertical direction V (direction of engagement). Thus, the roller 27 is guided along the seal 10 as it moves in the lengthwise direction L. The groove 41 engaging the protrusion 40 reduces the likelihood of slipping off in the transverse direction T with respect to the lengthwise direction L.

Also, as the roller 27 rolls along the seal 10 and in contact therewith, the hammer unit 23 exerts a hammering action on the roller 27. For example, the hammer unit 23 may comprise a crank mechanism (not shown) driven by an electric motor (not shown) powered in turn by the battery pack 25. The crank mechanism transforms the rotational movement of the electric motor into a reciprocating linear movement of the roller unit 26. The direction of the linear movement of the roller unit 26 is indicated by reference numeral R in FIGS. 7 and 9. The axis R passes at right angle through the rotational axis 28 of the roller 27. Also, that reciprocating movement is at right angles or substantially at right angles with the outer surface 38 of the seal 10. The axis R may be colinear with the direction of engagement V of the groove 41 and the protrusion 40.

The hammering action causes the roller 27 to push the seal 10 into its mounted position on the blade bearing 4. For example, the first portion 12 (see FIG. 3) is pushed into the groove 13 in the outer race 5. In addition, the second portion 14 (see again FIG. 3) of the seal 10 is pushed at least partially into the gap 9 between the outer race 5 and the inner race 6. Therein, the arms 15, 16 spread out elastically to provide the sealing of the gap 9. When the first portion 12 gets pushed into the groove 13, lips 42 on the first portion 12 get deformed to provide for a frictional connection between the seal 10 and the outer race 5.

When it is referred to the outer and inner race 5, 6 herein, this can also mean a respective outer and inner housing holding the outer and inner race 5, 6, respectively.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A tool for mounting a seal in a groove or gap on a wind turbine, the tool comprising: a roller configured for rolling along the seal and in contact therewith, and a hammer unit configured for exerting a hammering action on the roller to push the seal or a portion thereof into the groove or gap as the roller rolls along the seal, wherein the tool comprises a battery powering the hammer unit.

2. The tool of claim 1, wherein the roller is configured to engage the seal in a direction transverse with respect to the rolling direction.

3. The tool of claim 2, wherein the roller has, on its circumference, a groove configured to engage a protrusion on the seal.

4. The tool of claim 1, wherein the tool is a hand-held tool.

5. The tool of claim 1, wherein the roller is releasably connected to the hammer unit.

6. The tool of claim 5, further comprising a roller unit comprising the roller and a mount, wherein the hammer unit has a chuck receiving the mount for providing the releasable connection.

7. The tool of claim 1, further comprising a bracket comprising two legs and a dowel pin, wherein the roller is held rotatably by the dowel pin between the legs.

8. The tool of claim 2, wherein the seal is a blade bearing seal.

9. A method for mounting a seal in a groove or gap on a wind turbine using a tool, the method comprising:
rolling a roller of the tool along the seal and in contact therewith,
exerting, by a hammer unit of the tool, a hammering action on the roller to push the seal or a portion thereof into the groove or gap as the roller rolls along the seal, wherein the tool comprises a battery powering the hammer unit.

10. The method of claim 9, wherein the roller engages the seal in a direction transverse with respect to the rolling direction.

11. The method of claim 10, wherein the roller has, on its circumference, a groove engaging a protrusion on the seal.

12. The method of claim 9, wherein the tool is a hand-held tool.

13. The method of claim 9, wherein the roller is releasably connected to the hammer unit prior to the step of rolling the roller along the seal.

14. The method of claim 10, wherein the seal is a blade-bearing seal.

15. The method of claim 10, wherein the wind turbine has a hub, a blade and a blade bearing connecting the blade to the hub, wherein the blade bearing has an inner and outer race forming a gap therebetween, wherein the outer race has the groove in which a portion of the seal is mounted to seal the gap.
